(19) United States
(12) Patent Application Publication
(10) Pub. No.: US 2003/0077027 A1
(43) Pub. Date: Apr. 24, 2003

(54) Optical switching using bubble-driven droplet

(76) Inventors: Stefano Schiaffino, Menlo Park, CA (US); Richard E. Haven, Sunnyvale, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/034,095

(22) Filed: Oct. 23, 2001

(51) Int. Cl. G02B 6/35

(52) U.S. Cl. 385/18

(57) ABSTRACT

The present invention provides an optical switch in which generated bubbles displace a droplet to change the transmission characteristics of an optical path. A structure defines a cavity that is divided into first and second chambers that are in fluid communication with each other. The structure also defines an optical path that intersects the first chamber. The cavity is filled with a combination of liquids including a droplet and a displaceable liquid. Generating a bubble in the chamber containing the droplet moves the droplet to the other chamber, displacing the other liquid accordingly; the bubbles can be generating by heating resistors adjacent to each of the chambers. The index of refraction of the droplet differs from that of the displaceable liquid so that moving the droplet changes the transmission characteristics of the optical path.

### BACKGROUND OF THE INVENTION

The present invention relates to optical switches and, more particularly, to a device and method in which optical transmission is controlled by an index-of-refraction match or mismatch of a fluid along an optical path. Certain embodiments of the invention provide for a low-power, long-lasting, self-latching optical switch and for arrays of such switches.

As a result of the explosive growth in optical communications technologies, efforts are currently being made around the world to develop optical switch devices that have a large number of ports (i.e., that can handle a large number of wavelengths, or channels). Some of the technologies under development for this purpose include micro-electro-mechanical-systems (MEMS), solid-state devices, optical-electrical-optical (OEO) systems and fluid based devices. Despite the wide variety of approaches and technologies that have been used to create optical switching devices having a large number of ports, no solution that is both commercially and technically viable has yet been obtained. The lack of commercially and/or technically-viable solutions stems primarily from the requirements that must be met in order to obtain acceptable optical performance, which include low optical loss, low optical cross-talk, scalability to large port counts, low noise, high reliability, low operating power and reasonable costs.

A technology developed by Fouquet et al., which is the subject of U.S. Pat. No. 5,699,462, which is incorporated by reference herein in its entirety, is directed to manipulating thermally activated bubbles within small channels fabricated at the intersection of a system of optical waveguides. The small channels are filled with a refractive index-matching liquid, which when heated, vaporizes and forms a bubble in the gap. A small resistor is micro-fabricated at each of the intersections for heating the refractive index-matching liquid. In the transmitting state, the resistor at the optical waveguide intersection is not heated, and the optical signal travels through the intersection undisturbed due to the matching indices of refraction of the liquid filling the gap and the waveguides. In the reflective state, the refractive index-matching liquid is displaced from the gap by forming a bubble in the refractive index-matching liquid. This causes light to be reflected by total internal reflection, which results from the mismatch between the glass side wall and the fluid in the micro-channel. For good light reflection, continuous heating of the resistor at the intersection is required to prevent the switching mechanism from changing state. The bubble will collapse if the power to the resistor is removed, thereby causing the switching device to change its state.

Advantages of the approach taken by Fouquet et al. include scalability to a large number of ports, generally acceptable optical performance and fast switching capability. However, there are concerns with the approach that need to be addressed. These concerns include (i) instability of the bubble and its light-reflecting behavior over very long periods of time, (ii) the lack of a self-latching state, i.e., if power fails the state changes (e.g., the bubble collapses), (iii) the moderately high power requirements that must be met to prevent the state from changing (e.g., to maintain the bubble in place), (iv) the reliability of the resistor that is heated to generate the reflective state, since the resistor may be heated for very long periods of time and (v) optical cross-talk that can occur when multiple bubbles are being created simultaneously in the device.

Accordingly, a need exists for an optical switching device that is capable of: (i) providing stable light-reflecting behavior over very long periods of time; (ii) providing a self-latching state (i.e., if power fails the state will not change); (iii) reducing the power requirements that must be met to maintain state; (iv) improving the reliability of the resistor that is heated to produce the reflective state and (v) eliminating or reducing cross-talk that has occurred in the past when multiple bubbles are being created simultaneously in the device.

### SUMMARY OF THE INVENTION

The present invention provides an optical switching device in which generated bubbles displace a droplet to change the transmission characteristics of an optical path. A structure defines a cavity that is divided into first and second chambers that are in fluid communication with each other. The structure also defines an optical path that intersects the first chamber. The cavity is filled with a combination of liquids including a droplet and a displaceable liquid. Generating a bubble in the chamber containing the droplet moves the droplet to the other chamber, displacing the other liquid accordingly; the bubbles can be generating by heating resistors adjacent to each of the chambers. The index of refraction of the droplet differs from that of the displaceable liquid so that moving the droplet changes the transmission characteristics of the optical path.

For example, the displaceable fluid can provide an index-of-refraction match with surrounding segments of the optical path, while the droplet provides an index-of-refraction mismatch. When the droplet is in the second chamber, the first chamber is filled with the displaceable liquid so that light can be transmitted along the optical path through the first chamber. When the droplet is in the first chamber, light is reflected at the first chamber so that it is not transmitted further along the optical path (although it may be transmitted along another optical path). The droplet is preferably immiscible with the displaceable liquid and should remain contiguous even during transitions from one chamber to the other. In a preferred embodiment, the droplet is of liquid metal so that it provides an index-of-refraction mismatch, while the displaceable liquid provides the match.

In accordance with one example embodiment, an optical switching device is provided that comprises a structure having a cavity defining a first chamber and a second chamber, and a vapor bubble generation mechanism. The first and second chambers have openings at first ends thereof and are closed on second ends thereof. The openings at the first ends of the chambers are coupled to each other via a passageway. The first and second chambers each have a refractive index-matched fluid therein that has a refractive index that is at least substantially matched to refractive indices of the first and second chambers. One of the first and second chambers has a fluid, or liquid, droplet therein that has a refractive index that is substantially different from the refractive indices of the first and second chambers.

The vapor bubble generation mechanism is capable of causing a vapor bubble to be formed in the refractive index-matched fluid. If the droplet is in the first chamber, formation of the bubble in the first chamber by the vapor bubble generation mechanism causes the droplet to pass through the passageway into the second chamber. If the droplet is in the second chamber, formation of the bubble in the second chamber by the vapor bubble generation mechanism causes the droplet to pass through the passageway into the first chamber. In accordance with this embodiment, whichever chamber if droplet is not in corresponds to the light path of the switching device.

The present invention also comprises an optical switching apparatus that comprises at least one of the aforementioned optical switching devices. The optical switching apparatus has at least one light input port and at least one light output port through which light is coupled into and out of the optical switching apparatus. The first optical waveguide is coupled at a first end thereof to at least one input port and has a second end disposed adjacent the first chamber of the aforementioned optical switching device. A second optical waveguide has a first end disposed adjacent the first chamber of the optical switching device opposite the second end of the first optical waveguide. The second end of the second optical waveguide is coupled to at least one light output port. Depending on the location of the droplet in one of the chambers of the optical switching device, will or will not provide an optical path for the light from the input port to the output port.

The present invention also provides a method for performing optical switching. The method comprises the steps of providing the aforementioned optical switching device and forming a vapor bubble in the refractive index-matched liquid in one of the first and second chambers to control whether light is allowed to pass through the switching device.

In accordance with all of the embodiments of the present invention, the optical switching device is stable, meaning that once the droplet has been moved from one chamber to the other, the droplet will remain in place regardless of whether power is removed from the device. This is in contrast to prior devices and techniques in which power must be maintained to prevent the switching device from switching state. This feature, in turn, prevents bubbles from inadvertently forming and creating optical cross-talk in the apparatus in which the switching device is utilized. These and other features and advantages of the present invention will become apparent from the following description, drawings and claims.

### BRIEF DESCRIPTION OF THE DRAWINGS

FIG. 1 is a top view of a block diagram of an example embodiment of the optical switching device of the present invention arranged as a 4-by-4 optical switch.

FIG. 2A is a top view of one of the micro cavities comprised by the optical switching device of the present invention, which illustrates the transmission of light through the right chamber of the cavity when the droplet is positioned in the left chamber of the cavity.

FIG. 2B is a top view of the one of the micro cavities comprised by the optical switching device of the present invention, which illustrates the reflection of light away from the right chamber of the cavity when the droplet is positioned in the right chamber of the cavity.

FIG. 3 is a cross-sectional view of a portion of the optical switching device of the present invention comprised at one of the cross-points of the optical switching device shown in FIG. 1, and which comprises the micro cavity illustrated in FIGS. 2A and 2B.

### DETAILED DESCRIPTION OF THE PREFERRED EMBODIMENTS OF THE INVENTION

The present invention improves on the approach of Fouquet et al. described in U.S. Pat. No. 5,699,462 by providing optical switching devices at each intersection, or cross-point, of the optical switching apparatus. The present invention comprises a structure that defines a transmissive cavity comprised of two chambers that are in fluid connection by a small constriction and that are filled with a refractive-index matched liquid and with a liquid, or fluid, droplet, which preferably is a liquid metal droplet.

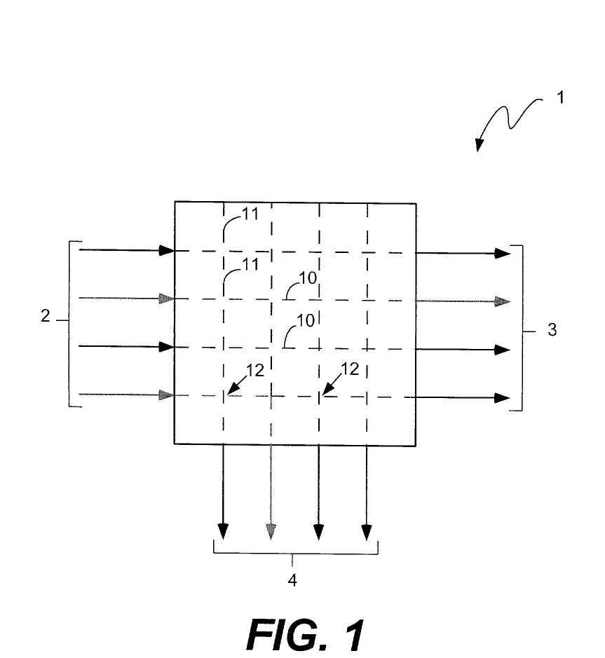

A top view of an example embodiment of the optical switching apparatus of the present invention is shown in FIG. 1. The light waveguides of the optical switching apparatus 1 are represented by the horizontal 10 and vertical 11 dashed lines. They are arranged in a matrix and intersect at N×N cross-points, where N is the number of channels being switched through the optical switching apparatus 1.

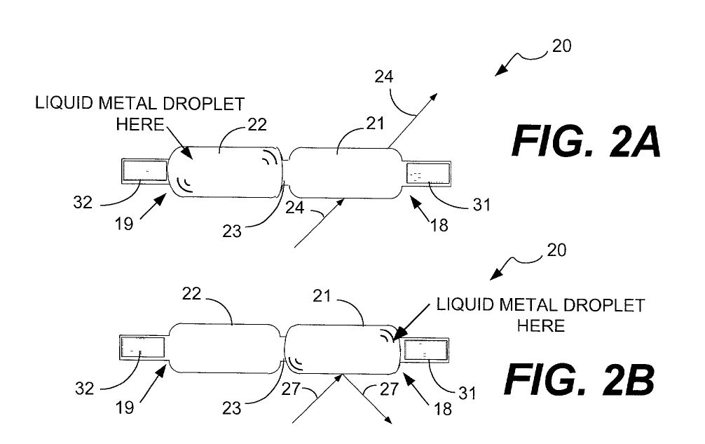

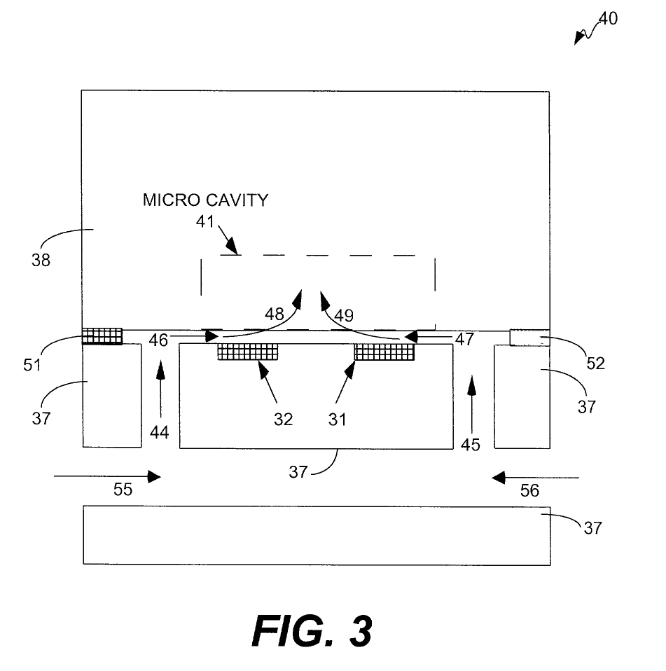

The cross-points, or intersections, are represented by the numeral 12. In the example embodiment shown in FIG. 1, N=4. At each cross-point 12, the light waveguides 10 and 11 are intersected by a cavity, which is part of the optical switching device 20 shown in FIGS. 2A, 2B and 3 and discussed below in detail.

In the example embodiment of FIG. 1, four incoming ports 2, each of which is configured to receive light from an optical fiber, are shown. Four output ports 3, each of which is configured to output light to an optical fiber, are also shown. The optical switching device 1 of FIG. 1 also comprises four output ports 4 to which light reflected at one of the 16 cross-points 12 is directed. The optical switching device 20 located at the cross-points 12 of the optical switching apparatus 1 is shown in the top view of FIGS. 2A and 2B. The optical switching device 20 has two ends 18 and 19, which are closed, and right and left chambers 21 and 22, respectively, which are separated by a small constriction 23 that is filled with (i) a fluid that has a refractive index that is matched to that of the silica (or whatever substrate material is used for this purpose) and (ii) a liquid, or fluid, droplet, such as a liquid mercury droplet, for example.

It has been found through experimentation that a liquid mercury/silica interface provides light reflecting characteristics that are suitable for purposes of the present invention. In order to maintain relatively low optical losses, it has been determined that, for this particular interface an angle of incidence of light of approximately 30° should chosen. Therefore, the cavity should be oriented in the planar light circuit so that the angle incidence of the light on the chamber containing the droplet in the reflecting state ensures suitable reflection and low optical loss. However, it should also be noted that the angle of incidence, and hence the orientation of the cavity, will depend on the type of liquid used as the droplet and on the type of material chosen for the substrate in which the cavity is formed. Therefore, as will be understood by those skilled in the art in view of the discussion provided herein that the present invention is not limited with respect to the orientation of the cavity or the angle of incidence of the light on the cavity. Well known Fresnel equations can be utilized to determine the materials and conditions that must be met to achieve low optical loss and proper reflection.

The optical switching device 20 located at the cross-points 12 also comprises a mechanism for generating vapor bubbles in the refractive index-matching liquid in order to actuate the switching. Preferably, the mechanism for generating vapor bubbles in the refractive index-matching liquid comprises resistors 31 and 32, which heat the chambers 21 and 22, respectively, of the cavity to perform the switching operations. When light (arrow 24) being transmitted along a waveguide 10 is to be transmitted through a cross-point 12, as is the case in FIG. 2A, the resistor 31 is heated, thereby causing a bubble to be formed in the refractive index-matching liquid that pushes the droplet through the constriction 23 into the left chamber 22, away from the light path, which, in this example embodiment, is coincident with the right chamber 21. Of course, the light path could, alternatively, be coincident with the left chamber 22, depending on the manner in which the optical switching devices 20 are intended to operate.

In this example, when light (arrow 27) is to be reflected, as is the case in FIG. 2B, the resistor 32 is heated, thereby causing a bubble to be formed in the refractive-index-matching liquid that forces the droplet through the constriction 23 into the right chamber 21, so as to occlude the passage of the light and reflect it (arrow 27) off of the boundary of the droplet and the wall of the right chamber 21 of the cavity. Once the droplet has been moved into its position in the left chamber 22 or the right chamber 21, it will rest there, constrained by the constriction 23 and the larger shape of the chambers 21 and 22 relative to the constriction 23. The resisters 31 and 32 are attached to conductive contacts (not shown) through which electrical power is provided to the resistors 31 and 32.

As stated above, in accordance with the present invention, it is only necessary to provide electrical power to the resistors 31 or 32 in order to move the droplet from one chamber to the other. No additional power is required to maintain the droplet in position once it is located within one of the chambers 21 or 22 of the cavity. This feature of the optical switching apparatus 1 of the present invention makes it a very low power apparatus because power does not need to be provided to the resistors 31 or 32 to maintain the droplet in the appropriate chamber 21 or 22. Also, since the resistors 31 and 32 are not required to be continuously heated in order to maintain the state of the optical switching device 20, they have a longer life expectancy, and therefore are more reliable. Furthermore, the optical switching device 20 is self-latching in that, after each switching operation occurs, no additional phase change (i.e., change in state) takes place. This self-latching feature of the optical switching device 20 of the present invention makes the optical switching device more robust than prior art devices in terms of long-term stability and eliminates or reduces the possibility of optical cross-talk. The combination of all of these features results in an optical switching apparatus that has increased stability and reliability, and that can be operated and maintained at relatively low costs.

Therefore, it can be seen that the optical switching apparatus of the present invention is capable of providing stable light reflection, since state will not change even if power is removed (i.e., the apparatus has self-latching characteristics). Power is only required in order to change state, which reduces overall power requirements and increases the life expectancy of the resistors. Optical cross-talk is eliminated due to the ability to precisely control the light path and prevent inadvertent state changes.

FIG. 3 is a cross-sectional side view of a portion 40 of the optical switching apparatus 1 of the present invention that corresponds to one of the optical switching devices 20 located at a cross-point 12. The gap between the silicon chip 37 and the silica chip 38 allows the refractive index-matched fluid to flow in the directions indicated by arrows 44, 45, 46, 47 48, 49, 55 and 56 to fill the chambers 21 and 22 of the cavity 41. The formation of the vapor bubble in the refractive index-matching liquid can be accomplished very quickly, which enables the optical switching devices 20 to be switched at very high speeds.

Solder rings 51 and 52 preferably are used to define and seal the fluid channels and to bond the silicon chip 37 to the silica chip 38. The refractive index-matched liquid, or fluid, at least substantially matches the refractive index of the walls of the cavity 41 so that substantially all of the light impinging on the cavity chamber having the bubble therein will be transmitted through the chamber without being refracted or reflected. In contrast, the refractive index of the droplet is substantially different from the refractive index of the walls of the cavity 41 so that substantially all of the light impinging on the cavity chamber having the droplet therein will be reflected, and thus re-directed along the associated optical waveguide 11 to one of the ports 4 shown in FIG. 1.

In order to achieve reliable bubble operation (i.e., to assure fast and reliable bubble creation and collapse), preferably the liquid metal fluid is degassed and the optical switching device 20 is hermetically sealed to prevent re-gassing of the fluid and loss of the fluid by evaporation. Preferably, the liquid metal fluid that is used for this purpose is oxygen-free so that oxidation of the droplet is prevented from occurring. Oxidation formation on the droplet could result in the formation of a skin of oxides on the droplet surface that could modify the wetting behavior of the droplet, and possibly degrade the light reflecting properties of the droplet. Also, in order to ensure a constant pressure environment and compliance of other system requirements, an independent pressure regulating chamber, or “hot tub” (not shown), preferably is used for housing the optical switching device 20. A suitable regulating chamber is described by Schiaffino et al. in U.S. Pat. No. 6,188,815, which is incorporated by reference herein in its entirety. The liquid metal (or other substance) droplets are delivered to each cavity of the optical switching device when the optical switching apparatus is fabricated. This can be accomplished by using a computer (not shown) running a program that controls a liquid metal drop-on-demand dispenser. Computer systems and liquid metal drop-on-demand dispensers controlled by the computer systems are known that are suitable for use with the present invention. Effective priming of the optical switching devices 20 preferably is accomplished by degassing the refractive index-matched fluid in a separate reservoir, evacuating the optical switching device 20, and by then allowing the refractive index-matched fluid to rush into the device 20. The fluid flow may be assisted by appropriate heating of the separate reservoir. Those skilled in the art will understand the manner in which these processes can be performed to suitably fabricate and make operational the optical switching apparatus 1 of the present invention.

Of course, those skilled in the art will understand that the embodiments discussed herein are example embodiments and are not intended to demonstrate exclusively the manners in which the present invention can be embodied. For example, the physical shape of the micro-cavities disposed at the cross-points is not limited to any particular shape or physical construction. It should also be noted that, although the present invention has been described with reference to a planar light circuit, those skilled in the art will understand that the concepts and principles of the present invention are applicable to non-planar and other contexts. Also, although the present invention has been described with reference to using two substrates that are bonded together to form the optical switching apparatus, a single substrate having the necessary properties could instead be used.

Furthermore, the droplet need not be limited to any particular material in order to enable the goals and advantages of the present invention to be achieved. Similarly, the refractive index-matched liquid is not limited to any particular material. However, a particular relationship between the droplet and the refractive index-matched liquid should be maintained in order for the present invention to operate properly. For example, the droplet and refractive index-matched liquid should be immiscible, both during rapid state transitions, and over longer device lifetimes (in order to extend the lifetime of the device). The function of the “droplet” is to displace the refractive index-matched liquid. Therefore, the droplet should remain contiguous.

The droplet should also not leave any residue behind in the chamber it is evacuating that would mix, or otherwise become distributed, in the refractive index-matched liquid. If this happened, then after many switching cycles, the droplet volume might decrease to the point where it would not be able to suitably displace the refractive index-matched liquid. Those skilled in the art will understand the manner in which a suitable droplet and a suitable refractive index-matched liquid can be chosen to meet these immiscible/contiguous constraints.

It should also be noted that although the preferred embodiment utilizes a resistor disposed adjacent each chamber of the cavity for heating the refractive index-matched liquid to for vapor bubble generation, this function could be accomplished through the use of some other type of mechanism. Also, although the discussion of the preferred embodiment assumes that the droplet is not refractive index-matched to the chambers, but rather is reflective, it could be that the droplet is the refractive index-matching fluid such that the chamber in which the droplet is located would correspond to the optical path when the device is in the transmissive state. In this case, the other liquid would have a refractive index that is not matched to that of the chambers, and the chamber in which it is located would not correspond to the optical path. Those skilled in the art will understand, in view of the discussion being provided herein, how other modifications to the embodiment described herein may be made that are within the scope of the invention.

What is claimed is:

1. An optical switching device comprising:
a structure having a cavity defining a first chamber and a second chamber, the first and second chambers having openings at first ends thereof and being closed on second ends thereof, the openings being coupled to each other via a passageway, the first and second chambers each having a refractive index-matched fluid therein that has a refractive index that is at least substantially matched to refractive indices of the first and second chambers, one of the first and second chambers having a fluid, or liquid, droplet therein that has a refractive index that is substantially different from the refractive indices of the first and second chambers; and
a vapor bubble generation mechanism capable of causing a vapor bubble to be formed in the refractive index-matched fluid, wherein if the droplet is in the first chamber, formation of the bubble in the first chamber by the vapor bubble generation mechanism causes the droplet to pass through the passageway into the second chamber, and wherein if the droplet is in the second chamber, formation of the bubble in the second chamber by the vapor bubble generation mechanism causes the droplet to pass through the passageway into the first chamber.

2. The optical switching device of claim 1, wherein the first chamber is coincident with a light path of the optical switching device, and wherein when the optical switching device is in a transmitting state, the droplet is in the second chamber and light is capable of passing through the first chamber.

3. The optical switching device of claim 2, wherein the vapor bubble generation mechanism comprises:
a first resistor positioned in proximity to the first chamber such that heating of the first resistor causes a bubble to be formed in the refractive index-matched fluid in the first chamber; and
a second resistor positioned in proximity to the second chamber such that heating of the second resistor causes a bubble to be formed in the refractive index-matched fluid in the second chamber, wherein if the droplet is in the first chamber, formation of the bubble in the first chamber causes the droplet to pass through the passageway into the second chamber, and wherein if the droplet is in the second chamber, formation of the bubble in the second chamber causes the droplet to pass through the passageway into the first chamber.

4. The optical switching device of claim 3, wherein when the optical switching device is in a reflecting state, the droplet is in the first chamber and light impinging on the first chamber is reflected at an interface between an inner wall of the first chamber and the droplet.

5. The optical switching device of claim 1, wherein once the droplet has been moved from the first chamber to the second chamber by formation of a bubble in the first chamber, the droplet will remain in the second chamber after power has been removed from the first resistor.

6. The optical switching device of claim 4, wherein once the droplet has been moved from the second chamber to the first chamber by formation of a bubble in the second chamber, the droplet will remain in the first chamber after power has been removed from the second resistor.

7. The optical switching device of claim 1, wherein the cavity is formed in a silica chip and the resistors are formed in a silicon chip, the refractive index-matching fluid being matched to a refractive index of the silica chip, the silica and silicon chips being bonded together.

8. The optical switching device of claim 1, wherein the droplet is a droplet of liquid mercury.

9. The optical switching device of claim 1, wherein the first and second chambers have respective maximum inner volumetric dimensions, and wherein the passageway has a maximum inner volumetric dimension that is smaller than maximum inner volumetric dimensions of the first and second chambers such that the passageway forms a constriction between the first and second chambers.

10. An optical switching apparatus, the optical switching apparatus having at least one light input port and at least one light output port, the apparatus comprising:
a switching device, the optical switching device comprising a cavity having a first chamber and a second chamber, the first and second chambers having openings at first ends thereof and being closed on second ends thereof, the openings being coupled to each other via a passageway, the first and second chambers each having a refractive index-matched fluid therein that is at least substantially matched to refractive indices of the first and second chambers, one of the first and second chambers having a fluid, or liquid, droplet therein that has a refractive index that is substantially different from the refractive indices of the first and second chambers;
a first optical waveguide being coupled at a first end thereof to said at least one input port and having a second end disposed adjacent the first chamber of the switching device;
a second optical waveguide having a first end disposed adjacent the first chamber of the switching device opposite the second end of the first optical waveguide, the second end of the second optical waveguide being coupled to said at least one light output port; and
a vapor bubble generation mechanism capable of causing a vapor bubble to be formed in the refractive index-matched fluid, wherein if the droplet is in the first chamber, formation of the bubble in the first chamber by the vapor bubble generation mechanism causes the droplet to pass through the passageway into the second chamber, and wherein if the droplet is in the second chamber, formation of the bubble in the second chamber by the vapor bubble generation mechanism causes the droplet to pass through the passageway into the first chamber.

11. The optical switching apparatus of claim 10, wherein the vapor bubble generation mechanism comprises:
a first resistor disposed in proximity to the first chamber such that heating of the first resistor causes a bubble to be formed in the refractive index-matched fluid in the first chamber; and
a second resistor disposed in proximity to the second chamber such that heating of the second resistor causes a bubble to be formed in the refractive index-matched fluid in the second chamber, wherein if the droplet is in the first chamber, formation of the bubble in the first chamber causes the droplet to pass through the passageway into the second chamber, and wherein if the droplet is in the second chamber, formation of the bubble in the second chamber causes the droplet to pass through the passageway into the first chamber, and wherein when the droplet is in the second chamber, light received at said at least one input port is allowed to pass to said at least one output port.

12. The optical switching apparatus of claim 11, wherein when the optical switching device is in a reflecting state, the droplet is in the first chamber and light impinging on the first chamber is reflected at an interface between an inner wall of the first chamber and the droplet.

13. The optical switching apparatus of claim 11, wherein when the droplet has been moved from the first chamber to the second chamber by formation of a bubble in the first chamber, the droplet will remain in the second chamber regardless of whether the first resistor is heated.

14. The optical switching apparatus of claim 11, wherein when the droplet has been moved from the second chamber to the first chamber by formation of a bubble in the second chamber, the droplet will remain in the first chamber regardless of whether the second resistor is heated.

15. The optical switching apparatus of claim 10, wherein the cavity is formed in a silica chip and the resistors are formed in a silicon chip, the refractive index-matching fluid being matched to a refractive index of the silica chip, the silica and silicon chips being bonded together.

16. The optical switching apparatus of claim 10, wherein the droplet is a droplet of liquid mercury.

17. The optical switching apparatus of claim 10, wherein the first and second chambers have respective maximum inner volumetric dimensions, and wherein the passageway has a maximum inner volumetric dimension that is smaller than maximum inner volumetric dimensions of the first and second chambers such that the passageway forms a constriction between the first and second chambers.

18. A method for performing optical switching, the method comprising the steps of:
providing a switching device comprising a structure defining a cavity having a first chamber and a second chamber, the first and second chambers having openings at first ends thereof and being closed on second ends thereof, the openings being coupled to each other via a passageway, the first and second chambers each having a refractive index-matched fluid therein that has a refractive index that is at least substantially matched to refractive indices of the first and second chambers, one of the first and second chambers having a fluid, or liquid, droplet therein that has a refractive index that is substantially different from the refractive indices of the first and second chambers;
forming a vapor bubble in the refractive index-matched liquid in one of the first and second chambers, wherein if the droplet is in the first chamber, formation of a vapor bubble in the refractive index-matched fluid in the first chamber causes the droplet to pass through the passageway into the second chamber, and wherein if the droplet is in the second chamber, formation of the bubble in the second chamber causes the droplet to pass through the passageway into the first chamber.

19. The method of claim 18, wherein the first chamber is coincident with a light path of the optical switching device, and wherein when the optical switching device is in a transmitting state, the droplet is in the second chamber and light is capable of passing through the first chamber.

20. The method of claim 19, wherein when the optical switching device is in a reflecting state, the droplet is in the first chamber and light impinging on the first chamber is reflected at an interface between an inner wall of the first chamber and the droplet.

21. The method of claim 20, wherein the step of forming a vapor bubble in the refractive index-matched liquid in one of the first and second chambers is performed by heating one of a first resistor and a second resistor of the optical switching device, the first resistor being disposed in proximity to the first chamber of the cavity, the second resistor being disposed in proximity to the second chamber of the cavity, wherein heating of the first resistor causes a bubble to be formed in the refractive index-matched fluid in the first chamber, and wherein heating of the second resistor causes a bubble to be formed in the refractive index-matched fluid in the second chamber, wherein if the droplet is in the first chamber, formation of the bubble in the first chamber causes the droplet to pass through the passageway into the second chamber, and wherein if the droplet is in the second chamber, formation of the bubble in the second chamber causes the droplet to pass through the passageway into the first chamber.

22. The method of claim 21, wherein once the droplet has been moved from the first chamber to the second chamber by formation of a bubble in the first chamber, the droplet will remain in the second chamber regardless of whether the first resistor is heated.

23. The method of claim 21, wherein once the droplet has been moved from the second chamber to the first chamber by formation of a bubble in the second chamber, the droplet will remain in the first chamber regardless of whether the second resistor is heated.

24. An optical switching device comprising:
a structure having a cavity defining first and second chambers in fluid communication with each other, said structure defining an optical path including said first chamber;
a combination of fluids disposed within said cavity, said combination of fluids including a droplet and a displaceable fluid, said droplet when in one of said chambers rendering said optical path transmissive, said droplet when in the other of said chambers rendering said optical path non-transmissive; and
bubble-generation means for propelling said droplet from one of said chambers to the other.

25. The optical switching device of claim 24, wherein the bubble-generation means comprises:
a first resistor positioned in proximity to the first chamber such that heating of the first resistor causes a bubble to be formed in the displaceable fluid in the first chamber; and
a second resistor positioned in proximity to the second chamber such that heating of the second resistor causes a bubble to be formed in the displaceable fluid in the second chamber, wherein if the droplet is in the first chamber, formation of the bubble in the first chamber causes the droplet to pass through the passageway into the second chamber, and wherein if the droplet is in the second chamber, formation of the bubble in the second chamber causes the droplet to pass through the passageway into the first chamber.

26. The optical switching device of claim 24, wherein when the optical switching device is in a reflecting state, the droplet is in the second chamber and light impinging on the first chamber is reflected at an interface between an inner wall of the first chamber and the displaceable fluid due to a mismatch between indices of refraction of the first chamber and the displaceable fluid.

27. The optical switching device of claim 24, wherein when the optical switching device is in a reflecting state, the droplet is in the first chamber and light impinging on the first chamber is reflected at an interface between an inner wall of the first chamber and the droplet due to a mismatch between indices of refraction of the first chamber and the droplet.

28. The optical switching device of claim 25, wherein once the droplet has been moved from the first chamber to the second chamber by formation of a bubble in the first chamber, the droplet will remain in the second chamber after power has been removed from the first resistor.

29. The optical switching device of claim 25, wherein once the droplet has been moved from the second chamber to the first chamber by formation of a bubble in the second chamber, the droplet will remain in the first chamber after power has been removed from the second resistor.

30. The optical switching device of claim 24, wherein the cavity is formed in a silica chip and the resistors are formed in a silicon chip, the refractive index-matching fluid being matched to a refractive index of the silica chip, the silica and silicon chips being bonded together.

31. The optical switching device of claim 24, wherein the droplet is a droplet of liquid mercury.

32. The optical switching device of claim 24, wherein the first and second chambers have respective maximum inner volumetric dimensions, and wherein the passageway has a maximum inner volumetric dimension that is smaller than maximum inner volumetric dimensions of the first and second chambers such that the passageway forms a constriction between the first and second chambers.

33. An optical switching method comprising generating a bubble in a displaceable fluid so as to propel a droplet from one chamber to another chamber of a structure so as to change the transmission characteristics of an optical path defined by said structure and including one of said chambers.

34. The method of claim 33, wherein generating a bubble in the displaceable fluid comprises:
forming a vapor bubble in the displaceable fluid in one of the first and second chambers, wherein if the droplet is in the first chamber, formation of a vapor bubble in the displaceable fluid in the first chamber causes the droplet to pass through a passageway into the second chamber, and wherein if the droplet is in the second chamber, formation of the bubble in the second chamber causes the droplet to pass through the passageway into the first chamber.

35. The method of claim 34, wherein the first chamber is coincident with the optical path, and wherein, in a transmitting state, the droplet is in the second chamber and light is capable of passing through the first chamber.

36. The method of claim 35, wherein, in a reflecting state, the droplet is in the first chamber and light impinging on the first chamber is reflected at an interface between an inner wall of the first chamber and the droplet.

37. The method of claim 34, wherein the first chamber is coincident with the optical path, and wherein, in a transmitting state, the droplet is in the first chamber and light is capable of passing through the first chamber.

38. The method of claim 37, wherein, in a reflecting state, the displaceable fluid is in the first chamber and light impinging on the first chamber is reflected at an interface between an inner wall of the first chamber and the displaceable fluid.

39. The method of claim 34, wherein forming a vapor bubble in the displaceable fluid in one of the first and second chambers is performed by heating one of a first resistor and a second resistor, the first resistor being disposed in proximity to the first chamber of the cavity, the second resistor being disposed in proximity to the second chamber of the cavity, wherein heating of the first resistor causes a bubble to be formed in the displaceable fluid in the first chamber, and wherein heating of the second resistor causes a bubble to be formed in the displaceable fluid in the second chamber, wherein if the droplet is in the first chamber, formation of the bubble in the first chamber causes the droplet to be propelled into the second chamber, and wherein if the droplet is in the second chamber, formation of the bubble in the second chamber causes the droplet to be propelled into the first chamber.

40. The method of claim 39, wherein once the droplet has been propelled from the first chamber to the second chamber by formation of a bubble in the first chamber, the droplet will remain in the second chamber regardless of whether the first resistor is heated.

41. The method of claim 39, wherein once the droplet has been propelled from the second chamber to the first chamber by formation of a bubble in the second chamber, the droplet will remain in the first chamber regardless of whether the second resistor is heated.
